(19) United States
(12) Patent Application Publication
(10) Pub. No.: US 2007/0085014 A1
(43) Pub. Date: Apr. 19, 2007

(54) Method and apparatus for charged particle-photon coincidence detection and uses for same

(75) Inventors: Justin I. McIntyre, West Richland, WA (US); James C. Hayes, Richland, WA (US); Matthew W. Cooper, Richland, WA (US); Michael D. Ripplinger, Kennewick, WA (US); April J. Carman, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/254,620

(22) Filed: Oct. 19, 2005

(51) Int. Cl. G01T 1/20

(52) U.S. Cl. 250/367

(57) ABSTRACT

A method and apparatus are disclosed for measuring charged particle and photon coincident radiation. The method and apparatus measure radioisotopes having beta-gamma coincident spectroscopies, providing spectral resolution and efficency that improve calibration and maintenance characteristics as well as isotope identifying characteristics important in industrial, defense, security, and human health applications.

This invention was made with Government support under Contract DE-AC05-76RLO1830 awarded by the U.S. Department of Energy. The Government has certain rights in the invention.

### FIELD OF THE INVENTION

The invention relates generally to a method and apparatus for charged particle-photon coincidence detection and uses for same.

### BACKGROUND OF THE INVENTION

Various radioisotopes, for example, certain isotopes of carbon (C), oxygen (O), argon (Ar), krypton (Kr), xenon (Xe), and radon (Rn), have coincident charged particle-photon (e.g., beta-gamma) spectrographic properties that can provide isotope-identifying characteristics important in industrial, defense, security, and human health applications. For example, the presence and concentration of certain radioxenon isotopes, made up of several radioactive gas species, are tell-tale signs of nuclear fission important in the monitoring of radioactive releases from nuclear detonations, a major component of the International Monitoring System of the Comprehensive-Nuclear-Test-Ban-Treaty. Unique signatures for these various gaseous isotopes include, but are not limited to, e.g., beta-gamma signatures, conversion electron (CE) signatures, and X-ray signatures. Current devices to measure such signatures, however, have numerous interdependent detectors requiring complex gain matching and calibration protocols and present maintenance and quality assurance/control challenges. Accordingly, new and improved detectors and monitoring systems are needed to provide spectroscopic data for determining isotopic compositions based on charged particle-photon coincidence.

### SUMMARY OF THE INVENTION

In one aspect of the invention, an apparatus is disclosed for measuring charged particle-photon coincident radiation emanating from an analyte gas. In one embodiment, the apparatus includes one or more coincidence detection cells, each cell including a charged-particle detector and a photon well detector. The charged-particle detector includes a chamber for containing an analyte gas and is composed of a charged-particle sensitive scintillating material. The charged-particle detector further includes a first means for detecting scintillation events from charged-particle radiation emanating from the analyte gas. The chamber and the first means define a first axis of symmetry. The photon well detector includes a photon sensitive scintillating material defining a well, and a second means for detecting scintillation events from photon radiation emanating from the gas, the well and the second means defining a second axis of symmetry. The chamber resides substantially within the well of the well detector. The configuration brings first and second axes in substantially collinear alignments providing, for example, measurement of charged-particle and photon coincident radiation in a simplified, efficient, and compact manner.

In another aspect of the invention, a method is disclosed for measuring charged particle and photon coincidence radiation emanating from an analyte gas. In one embodiment, the method includes providing one or more concidence detection cells, each cell including a charged-particle detector and a photon well detector. The charged-particle detector includes a chamber for containing an analyte gas and is composed of a charged-particle sensitive scintillating material. The charged-particle detector further includes a first means for detecting scintillation events from charged-particle radiation emanating from the analyte gas. The chamber and the first means define a first axis of symmetry. The photon well detector includes a photon sensitive scintillating material defining a well, and a second means for detecting scintillation events from photon radiation emanating from the gas, the well and the second means defining a second axis of symmetry. The chamber resides substantially within the well of the well detector. The method brings first and second axes in substantially collinear alignment providing, for example, measurement of charged-particle and photon coincident radiation in a simplified, efficient, and compact manner.

In other embodiments, the chamber is composed of various organic or inorganic charged-particle sensitive scintillating materials.

In another embodiment, the photon radiation is gamma radiation.

In yet another embodiment, the charged particle radiation is from beta particle or conversion electron radiation.

In other embodiments, the photon sensitive scintillating material is selected from the group consisting of Sodium Iodide (Nal), Cesium Iodide (Csl), Bismuth Germanate (BGO), Gadolinium Silicate (GSO), LaCl₃, LaBr₃, or combinations thereof.

In various other embodiments, the photon sensitive scintillating material is doped with an element selected from sodium (Na), thallium (TI), cesium (Cs), cerium (Ce), or combinations thereof, or the like.

In another embodiment, the photon sensitive scintillating material is Csl doped with Na.

In yet another embodiment, the charged-particle sensitive scintillating material is an organic scintillating material.

In yet another embodiment, the charged-particle sensitive scintillating material is a plastic scintillating material.

In yet another embodiment, the charged-particle sensitive scintillating material is an inorganic scintillating material.

In other embodiments, the inorganic scintillating material is selected from silicon (Si), calcium fluoride (CaF), cerium doped yttrium-aluminum-perovskite (YAP:Ce), or combinations thereof.

In another embodiment, the interior surface of the chamber comprises a memory reduction material.

In another embodiment, the memory reduction material is selected from CaF, YAP, or combinations thereof.

In another embodiment, the external surface of the chamber is in contact with a photon reflective material.

In another embodiment, the photon reflective material is Teflon@.

In another embodiment, the first means for detecting scintillation is selected from photomultiplier tube, photocathode, photodiodes, phototransistor, or combinations thereof.

In another embodiment, the first means for detecting scintillation is a photomultiplier tube oversized to optimize collection efficiency from the chamber.

In another embodiment, the first means for detecting scintillation is a photomultiplier tube with a window diameter greater than the diameter of the chamber to optimize collection efficiency from the chamber.

In another embodiment, the second means for detecting scintillation is selected from photomultiplier tubes, photocathodes, photodiodes, phototransistors, charge-coupled devices, or combinations thereof.

In another embodiment, the second means for detecting scintillation is a photomultiplier tube oversized to optimize collection efficiency from the chamber.

In another embodiment, the second means for detecting scintillation is a photomultiplier tube with a window diameter greater than the diameter of the chamber to optimize collection efficiency from the chamber.

In another embodiment, the analyte gas is selected from carbon, oxygen, argon, krypton, xenon, radon, or combinations thereof.

In another embodiment, the analyte gas is concentrated by at least a factor of about 1000 providing sufficient concentration whereby low-concentration radioisotopes in the gas can be measured.

In another embodiment, the analyte gas comprises more than one isotope and/or daughter products thereof.

In another embodiment, the chamber includes a rounded end to increase scintillation collection for detecting scintillation by the first means.

In another embodiment, the apparatus comprises four coincidence detection cells configured in a square (2×2) matrix.

In another embodiment, the chamber has a wall thickness such that charged particle scintillation events are substantially captured by the charged particle sensitive scintillating material and coincident photons are not significantly captured by the charged particle sensitive scintillating material.

In another embodiment, the wall thickness is in the range from about 0.1 mm to about 2.0 mm.

In another embodiment, the measurement of charged particle-photon coincident radiation is used for spectroscopic analysis of the analyte gas

### TERMS

The term “scintillation event” as used herein refers to the emission of light in a scintillating material when the scintillating material interacts with high energy photons and/or charged particles emitted by radiation emanating from an analyte gas.

The terms “first means” and “second means” in reference to detecting scintillation events refers to any of a number of electronic devices and/or components known in the art, including, but not limited to, e.g., photomultiplier tubes (PMT), photocathodes, photodiodes, phototransistors, charge-coupled devices (CCD), voltage dividers, or combinations thereof, that convert or assist in conversion of light from a scintillating event in a scintillation material into an electrical signal. PMTs find use as components in, e.g., spectroscopic instruments that measure X-ray and gamma energies. A photomultiplier typically comprises a photocathode for converting photons (e.g., from scintillation events) into electrons; a multiplier chain, i.e., strings of successive electron absorbers having enhanced secondary emission (dynodes) wherein the entire string uses electric fields to accelerate the cascading electrons; and an anode that collects resulting current. Commercial PMTs vary in speed and linearity of response, in the time fluctuations of the signal, in amplification factor (called “gain”), and in the accepted wavelength spectrum.

The term “photodiode” as used herein has its customary meaning as will be understood by those of skill in the art, referring to any of a diverse class of optically sensitive electrical components and/or devices with “p-n” semiconductor junctions designed to be responsive to optical signals and/or inputs. Photodiodes include, but are not limited to, e.g., zero bias and reversed-bias photodiodes. Light falling on a zero bias diode causes a voltage to develop across the device, leading to a current in the forward bias direction, the so-called “photovoltaic effect”. Reversed-bias photodiodes are characterized as having high resistance that is reduced when light of an appropriate frequency reaches the junction. No limitations are hereby intended.

The term “phototransistor” refers to any of a number of standard transistors of a type including, e.g., bipolar transistors that are encased in, e.g., a transparent case such that light can be collected and directed to a base collector diode for measurement. The phototransistor works much like a photodiode, but with a much higher sensitivity for light, because electrons that tunnel through the Base-Collector diode are amplified by the transistor. Phototransistors have slower response times than typical photodiodes.

The term “charge-coupled device” (CCD) refers to any of a number of suitable light-sensitive integrated circuits capable of storing and displaying data for an image in such a way that each pixel (picture element) in the image is converted into an electrical charge, the intensity of which corresponds to a color in the electromagnetic (color) spectrum.

Other allied components and devices may be coupled to the first and second means, including, but not limited to, e.g., voltage dividers, analog-to-digital (A/D) converters (ADC), high-voltage (HV) power supplies, and the like for conditioning signals. No limitations are intended. All components as will be contemplated by those of skill in the art are within the scope of the disclosure.

The term “resides substantially within” in reference to the insertion of the charged particle detector into the well of the photon well detector means a depth sufficient to maximize the solid angle for optimum collection of scintillation events within the charged particle detector thereby providing a transmission efficiency of up to 100%.

The terms “first axis of symmetry” and “second axis of symmetry” in reference to the charged particle detector and photon well detector, respectively, mean the components of each detector have centers aligned along a virtual axis that passes through the center of each detector and its components. In various embodiments, alignment of these respective axes of symmetry provides a charged particle-photon coincidence detection apparatus with coincidence detection cells having a collinear design, and methods for measuring charged particle-photon coincidence radiation, as described herein.

### BRIEF DESCRIPTION OF THE DRAWINGS

FIG. 1 presents an exploded view of a new coincidence detection apparatus, comprising a charge-particle detector for detection of beta and electron conversion energies and a photon well detector for detection of gamma energies, according to an embodiment of the invention.

FIGS. 2a-2c present three views of the charged particle detector, a first showing a top-side view along the inlet tube (2a); the second a horizontal cross-sectional view showing the chamber, and first means for detecting scintillation events (2b); and the third showing a top-down whole view of the charged particle detector (2c).

FIGS. 3a-3d present four views of the beta tube body, the first showing combined horizontal and vertical cross-sectional views and corresponding dimensions (3a); the second showing another horizontal cross-sectional view orthogonal to that in FIG. 3a with corresponding dimensions (3b); the third showing another horizontal cross-sectional view orthogonal to that in FIG. 3b with corresponding dimensions (3c); and the fourth showing a top-down whole view (3d).

FIGS. 4a-4d present four views of the chamber nipple cap, a first vertical cross-sectional view with corresponding dimensions (4a); a second horizontal cross-sectional view with corresponding dimensions through the length of the nipple cap (4b); a third showing a vertical cross-sectional view through the width of the nipple cap (4c); and the fourth showing a top-down view of a vertical lengthwise cross-section of the nipple cap that traverses the gas inlet access point (4d).

FIGS. 5a-5c present three views of the beta tube end cap, the first showing a back end-on view (5a), the second showing a vertical side-on view and respective dimensions (5b), and the third showing a top-down view (5c).

FIGS. 6a-6b present two views of the chamber, a first showing a vertical cross-section through the chamber (6a), the second showing a vertical cross-section through the top half of the chamber and respective dimensions (6b) including respective dimensions for the inlet port.

FIGS. 7a-7b present two views of the chamber end cap (disk), the first showing a back end-on view (7a), the second showing a cross-sectional vertical view and their respective dimensions (7b).

FIGS. 8a-c present three views of the photon well detector, the first showing a horizontal end-on view, including high-voltage and signal connections (8a), the second showing a cross-sectional vertical side view (8b), and the third showing a horizontal side view including dimensions (8c).

FIG. 9 illustrates a beta-gamma coincidence detection apparatus configured with four coincidence detection cells, according to an embodiment of the invention.

FIG. 10 presents a simple system for coupling scintillation components of coincidence detection assembly.

FIG. 11 is a calibration curve for a photon well detector of a coincidence detection cell.

FIG. 12 is a plot showing resolution of calibration lines for peaks comprising the calibration curve of FIG. 11 for the photon well detector.

FIG. 13 presents a histogram of a Csl(TI) response of the photon well detector tested in conjunction with a radiological standard.

FIG. 14 is a plot showing the 2-dimensional beta-gamma coincidence histogram illustrating the constant energy line of a ¹³⁷Cs gamma source indicative of Compton scattering.

FIG. 15 is a plot highlighting the narrow regions in the beta-gamma histogram of FIG. 14 at appropriate gamma energies along the beta axis, and a Compton scattering endpoint energy.

FIG. 16 is a plot showing total light collected for the chamber measured with and without an exterior surface coating of Teflon®.

FIG. 17 is a plot showing the 2-dimensional beta-gamma coincidence histogram of a radioxenon gas comprising ¹³³Xe and ^{131m}Xe.

FIG. 18 is a plot showing projection of two regions of FIG.17.

### DETAILED DESCRIPTION

Various radioisotopes, for example certain isotopes of carbon (C), oxygen (O), argon (Ar), krypton (Kr), xenon (Xe), and radon (Rn) have coincident charged particle-photon (e.g., beta-gamma) spectroscopic properties that can provide isotope-identifying characteristics important in industrial, defense, security, and human health applications. For example, isotopes of xenon (Xe) offer unique signatures and advantages for detecting various types of nuclear fission events, including nuclear detonation. Nuclear fission produces large amounts of xenon in both direct production (independent yield) and chain yield (cumulative yield) processes. Xe is a chemically inert gas that will likely escape even from an underground nuclear explosion. The isotopes ¹³³Xe and ¹³⁵Xe and the metastable states of ^{131m}Xe and ^{133m}Xe are well suited for explosion monitoring, with decay half-lives ranging from 0.4 to 11.8 days. TABLE 1 herein lists dominant decay modes of exemplary radioxenon isotopes. Measuring the relative fraction of each isotope furnishes clues to the origin of the radioxenon sample. As reported by Bowyer et al. (Encyclopedia of Environmental Analysis and Remediation, Wiley, N.Y., 1998, pp. 5299-5314), radioxenon produced in an explosion is predicted to have a ratio for ^{133m}Xe to ¹³³Xe that is approximately 100 times greater than that of xenon released from a nuclear reactor in equilibrium. Monitoring this particular ratio gives excellent sensitivity to explosions, since both ¹³³Xe and ^{133m}Xe are produced in large amounts during an explosion with decay half-lives of 5.24 and 2.19 days, respectively. A detector system for radioxenon must quantitatively identify the radioxenon isotopes and any background in samples with very low activity. Although the isotopes ¹³³Xe and ¹³⁵Xe can be identified with conventional high-resolution gamma spectroscopy of the residual ¹³³Cs and ¹³⁵Cs nuclei, the metastable states ^{131m}Xe and ^{133m}Xe are highly converted with emission of a conversion electron and a xenon X-ray. The beta decay of ¹³³Xe proceeds with 99% abundance to the 81 keV excited state in ¹³³Cs. The 81 keV state is converted in approximately 63% of its decays and gives rise to Cs “K” X-rays with 49% abundance. The Xe and Cs X-rays cannot be resolved from each other by the Nal(TI) detector so electron energy spectroscopy is required to identify the conversion electrons from ^{131m}Xe, ^{133m}Xe, and ¹³³Xe.

These complex requirements can be met by a charged particle-photon coincidence detection apparatus and a method for measuring same, as detailed in various embodiments herein. The person or skill in the art will recognize that coincidence detection components and equipment described herein can be appropriately scaled or modified as necessary to address other specific isotopes or applications, industrial requirements, and/or analytical processes without deviating from the spirit and scope of the invention. All equipment and components as will be selected by those of skill in the art are hereby incorporated. No limitations are intended by the disclosure.

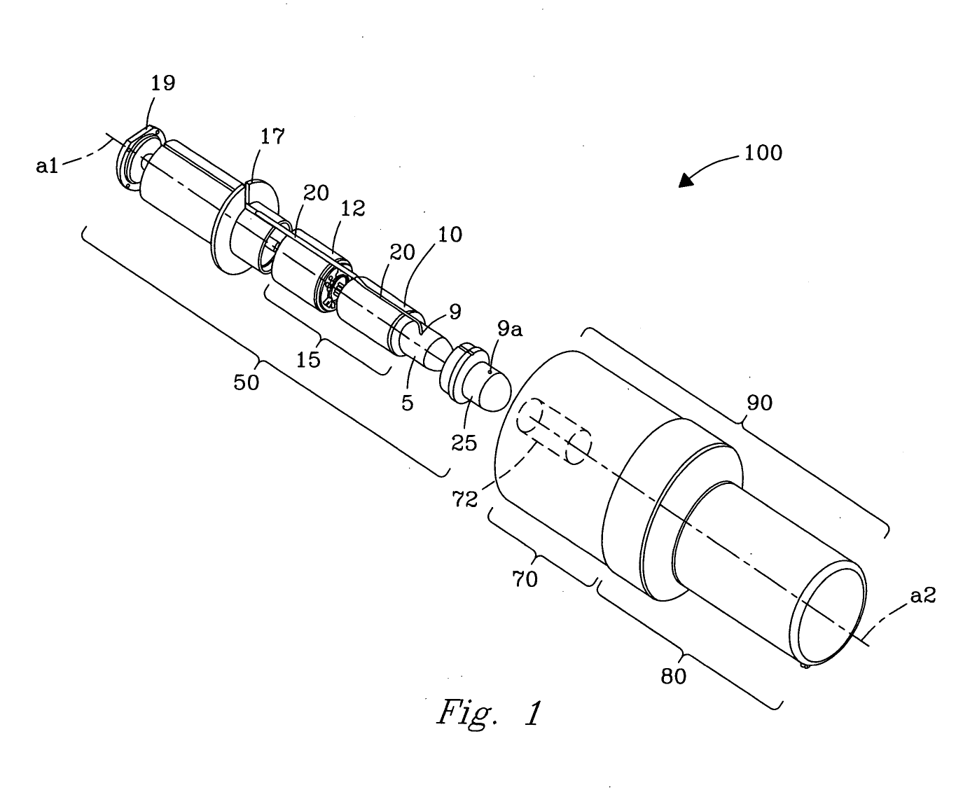

A coincidence detection apparatus (cell) 100 for beta-gamma coincidence measurements will now be described with reference to FIG. 1.

FIG. 1 presents an exploded view of a new coincidence detection apparatus 100, according to one embodiment of the invention. Apparatus 100 comprises a charge-particle detector 50 for detection of beta particles and conversion electrons (CE) and associated energies, and a photon well detector 90 for detection of gamma radiation and associated energies.

As illustrated in FIG. 1, charged particle detector 50 has a substantially axial symmetry, defined as a first axis of symmetry al. Charge-particle detector 50 includes the following components: a chamber 5, e.g., a Bicron® model 200 chamber or the like (Saint-Gobain, Newbury, Ohio, USA) for housing a gas analyte; a first means 15 for detecting scintillating events; a beta tube body 17; a beta tube end cap 19; and a nipple cap 25, described further hereafter.

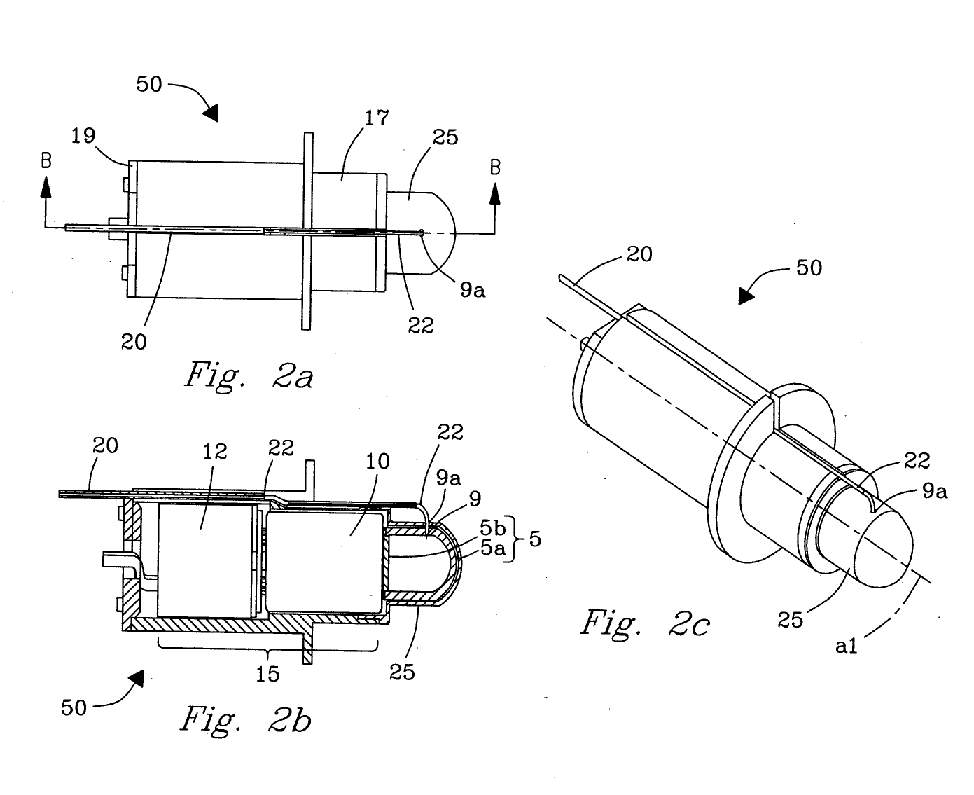

Chamber 5 (described further in reference to FIG. 2b below) comprises a chamber body 5a and an end cap 5b for sealing chamber 5. Chamber 5 is composed of a charged particle sensitive scintillating material including, but not limited to, e.g., an organic scintillating material, an inorganic scintillating material, or the like. Organic scintillating materials include, but are not limited to, e.g., plastic scintillating materials, e.g., Bicron® BC-404® (Saint-Gobain, Newbury, Ohio, USA) or the like. No limitations are intended. Inorganic scintillating materials include, but are not limited to, e.g., Silicon (Si), Calcium Fluoride (CaF), cerium-doped yttrium-aluminum-perovskite (YAP:Ce), Bismuth Germanate (BGO), Gadolinium Silicate (GSO), or combinations thereof. In one embodiment, illustrated in FIG. 2b below, chamber body 5a of chamber 5 has a rounded end for maximizing solid angle and light collection of detector 50.

In this embodiment, the gas analyte introduced to chamber 5 is any gas or gas mixture having suitable beta-gamma coincident spectroscopic properties, the spectroscopy providing isotope-identifying characteristics of importance. Gas analytes, include, but are not limited to, those containing isotopes of carbon (C), oxygen (O), argon (Ar), krypton (Kr), xenon (Xe), radon (Rn), and combinations thereof. No limitations are intended. Analyte gas is introduced into chamber 5 via gas transfer tube 22 through gas inlet port 9 directly into chamber 5.

First means 15 includes components for detecting scintillating events in the scintillating material of chamber 5 selected from, e.g., a photomultiplier tube (PMT) 10, [e.g., a Bicron® model 9111SB photomultiplier tube (Electron Tubes, Rockaway N.J., USA) or a model R6233 photomultiplier tube (Hamamatsu Photonics, K.K., Hamamatsu City, Japan) or the like], a voltage divider 12, [e.g., a model E673-01 voltage divider (Electron Tubes, Rockaway N.J., USA) or model AS10 (Hamamatsu Photonics, K. K., Hamamatsu City, Japan) or the like] or like components, including, but not limited to, e.g., photocathodes, photodiodes, phototransistors, CCDs, or combinations thereof. No limitations are intended.

Referring again to FIG. 1, beta tube body 17 houses first means 15 for detecting scintillating events of charged particle detector 50. Beta tube body 17 further couples to chamber 5, which is capped by nipple cap 25 blocking spurious external light from entering chamber 5. Nipple cap 25 further includes access point 9a into which gas transfer tube 22 inserts. Transfer tube 22 further links with tube 20 that runs along the exterior surface of beta tube body 17. Beta tube end cap 19 closes beta tube body 17 constraining internal components of charged-particle detector 50. Beta tube body 17, nipple cap 25, and beta tube end cap 19 are fabricated of materials including, but not limited to, e.g., Acrylonitrile-Butadiene-Styrene (ABS) plastics, acetal plastics (e.g., Delrin®), or the like, available commercially (Port Plastics, Portland, Oreg., USA). Such materials have desirable properties including the ability to block X-rays.

Referring again now to FIG. 1, photon well detector 90 (Saint-Gobain, Newbury, Ohio, USA) comprises a well 72 defined by a photon-sensitive scintillating material 70, including, but not limited to, undoped and doped scintillating materials. Undoped scintillating materials include, but are not limited to, e.g., Sodium Iodide (Nal), Cesium Iodide (Csl), Bismuth Germanate (BGO), Gadolinium Silicate (GSO), LaCI₃, LaBr₃, or combinations thereof. Doped scintillating materials further comprise at least an additional element selected from sodium (Na), thallium (TI), cesium (Cs), cerium (Ce), or combinations thereof, e.g., Nal(TI), Csl (Na), Csl(TI), or like doped forms. Selection of scintillation materials allows for detection of multiple scatter events, whether the event is a background spectrum or an event associated with, e.g., high energy muons, or other charged particles (e.g., from cosmic-rays), or high-energy terrestrial gamma-rays from ²³⁸U, ²³²Th daughter decays or ⁴⁰K that interact within the selected material. No limitations are intended. Well detector 90 further comprises a second means 80 for detecting scintillation events, including, but not limited to, e.g., PMTs, voltage dividers, photocathodes, photodiodes, phototransistors, charge-coupled devices (CCDs), or combinations thereof. As illustrated in FIG. 1, photon well detector 90 has a substantially axial symmetry, defined as a second axis of symmetry a2. In an embodiment, well detector 90 comprises a Csl(Na) scintillating material.

Referring again now to FIG. 1, in the assembled coincidence apparatus (cell) 100, charged particle detector 50 and well detector 90 are coupled such that first and second axes of symmetry, a1 and a2, respectively, align in a substantially collinear manner, providing, for example, a compact and efficient beta-gamma detection system. Chamber 5 is inserted into the well 72 of well detector 90, the insertion depth in well 72 depending on factors including, but not limited to, e.g., choice of scintillating material (Nal, Csl, etc.), well geometry, and/or optimization for capturing scintillation events. In an embodiment, illustrated in FIG. 8c below, chamber 5 of charged particle detector 50 is inserted into the 5.1 cm (˜1.995 inch) well 72 of well detector 90 (e.g., of the Nal detector 90), reaching a minimum depth of 5.5 cm (˜2.17 inches), thereby providing maximum solid angle coverage, but is not limited thereto.

To achieve the best possible beta energy and conversion electron (CE) energy resolution, chamber 5 may be coupled to an oversized PMT 10, wherein the PMT window diameter is greater than the diameter of chamber 5. In one embodiment, the PMT window diameter is greater than the diameter of chamber 5 by a value of about 8 mm (˜0.31 inches), thereby achieving maximum collection efficiency in PMT 10 from chamber 5, but is not limited thereto. Gain matching is not required given use of a single PMT in each detector 50 and 90, e.g., PMT 10 coupling to chamber 5 in detector 50, and a single PMT (not shown) coupling to photon sensitive scintillation material in well detector 90. Timing for scintillation events occurring within coincidence detector 100 is easily matched. Thus, the instant configuration provides for rapid set-up and calibration of coincidence detector 100.

A thin layer of optical epoxy, e.g., BC-600 optical cement (Saint-Gobain, Newbury, Ohio, USA) can be applied to the contacting surface between chamber end cap 5b and a slightly abraded of chamber body 5a to reduce scintillation losses between, e.g., chamber 5/beta tube body 17 interface.

In general, coincidence detector assembly 100 has close to 100% detection efficiency for measuring radiation events within an analyte gas. The coincidence detector design benefits from greater than 3.5π solid angle coverage for both classes of nuclear emissions, adequate energy resolution, robust scintillation material for field use, and minimal attenuation of X-rays and low-energy gammas.

Coincidence detection apparatus 100, including detectors 50 and 90 and associated components are further described in reference to following figures.

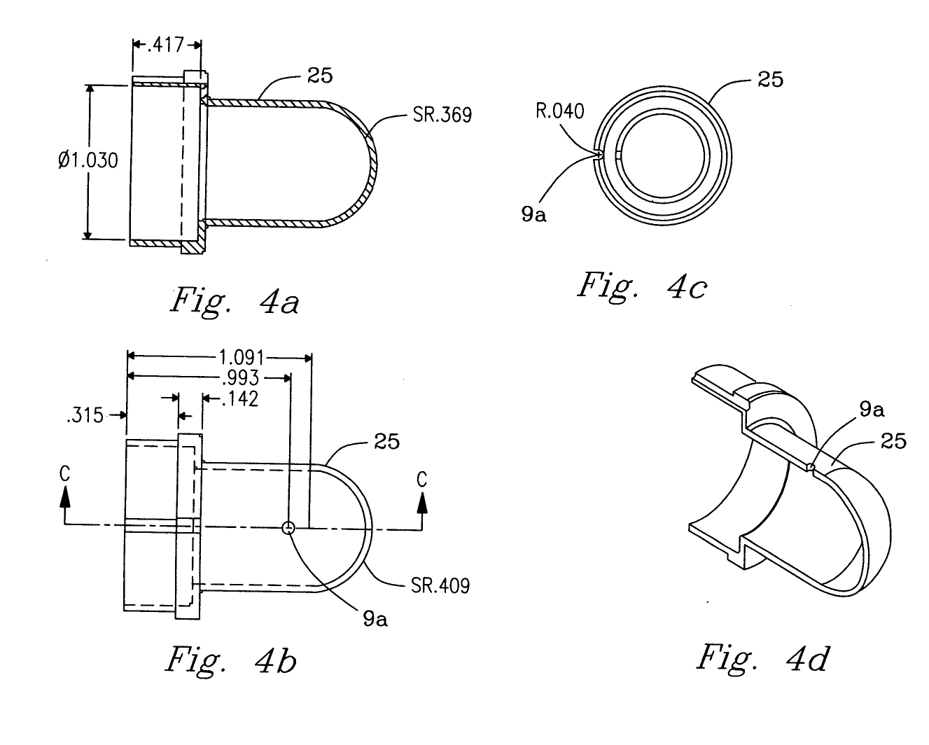

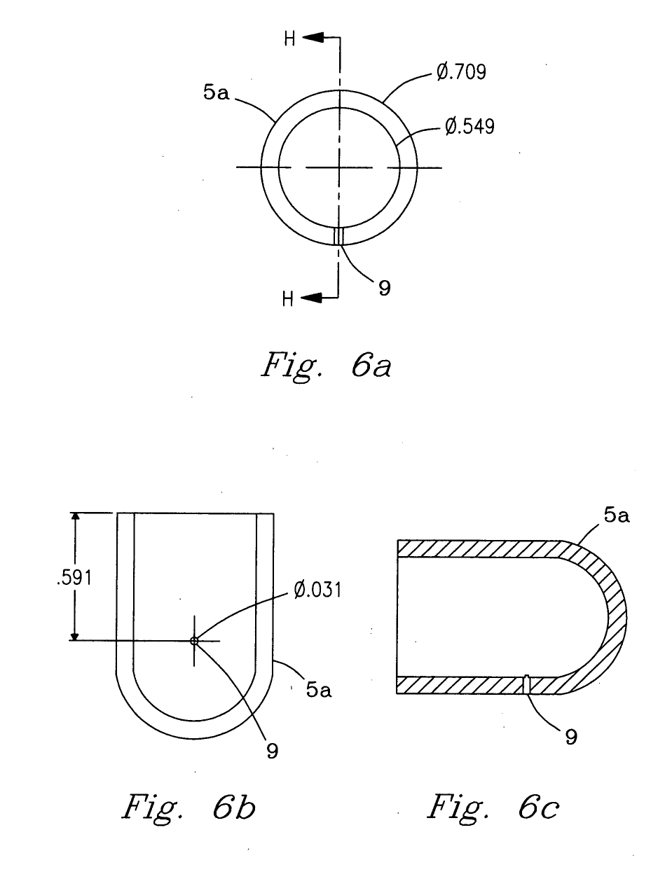

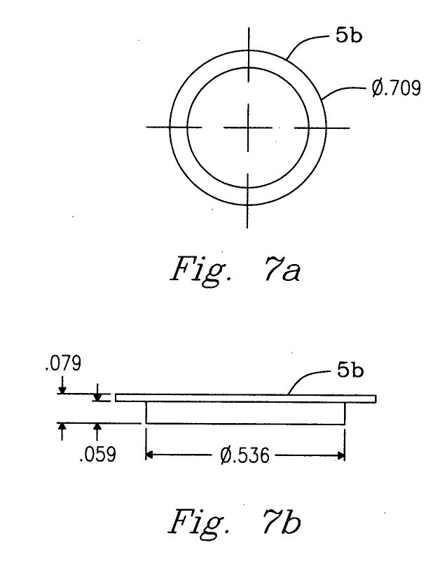

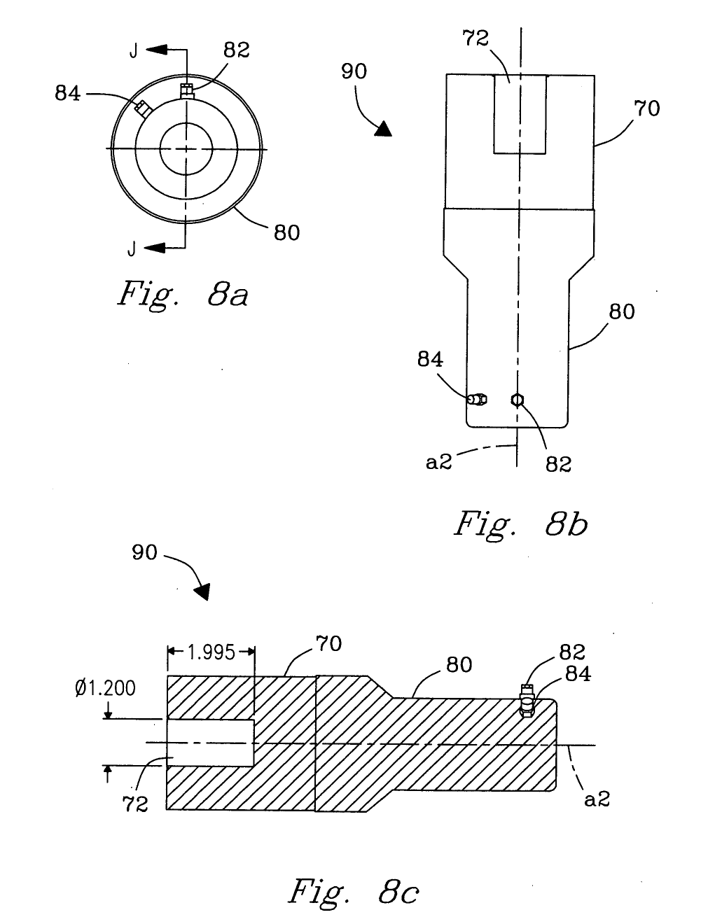

FIGS. 2a-2c present three views of charged particle detector 50. FIG. 2a shows a top-down outside view along the path of tube 20. In the figure, illustrated are the nipple cap 25 (for capping chamber 5), beta tube body 17 (for housing first means 15 and associated components, including PMT 10 and voltage divider 12), and beta tube end cap 19. Nipple cap 25 includes an access point 9a for insertion of gas transfer tube 22. FIG. 2b presents a vertical cross-sectional view of charged particle detector 50. In the figure, illustrated are the chamber body 5a and end cap 5b of chamber 5. End cap 5b is of a stepped design for sealing chamber 5. Chamber 5 is optically coupled to a first means 15 for detecting scintillation events, first means 15 comprising photomultiplier tube (PMT) 10 coupled to voltage divider 12. Tube 20 has dimensions of ˜ 1/32-inch O.D. as it reaches access point 9a (radial dimension of ˜0.040 inches, see FIG. 4c) where analyte gas enters into chamber 5 through gas inlet 9 (radial dimension of ˜0.030 inches, see FIG. 6b), but is not limited thereto. In an embodiment, chamber 5 is 28 mm long by 18 mm in diameter with 2 mm thick plastic scintillation walls. FIG. 2c presents an external view of charged particle detector 50. Tube 20 runs along the length of detector 50 becoming tube 22 with smaller dimension at access point 9a. Access point 9a provides for insertion of gas transfer tube 22, for introducing gas analyte to chamber 5.

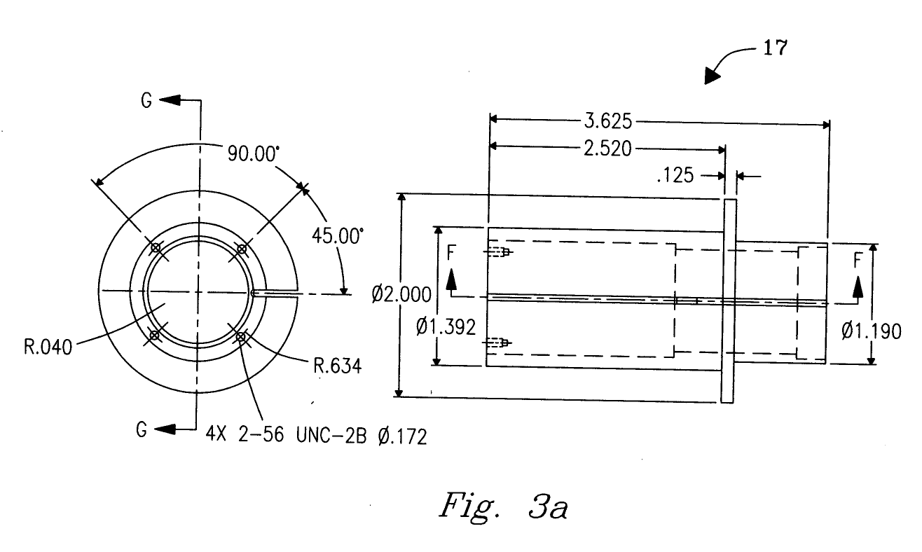

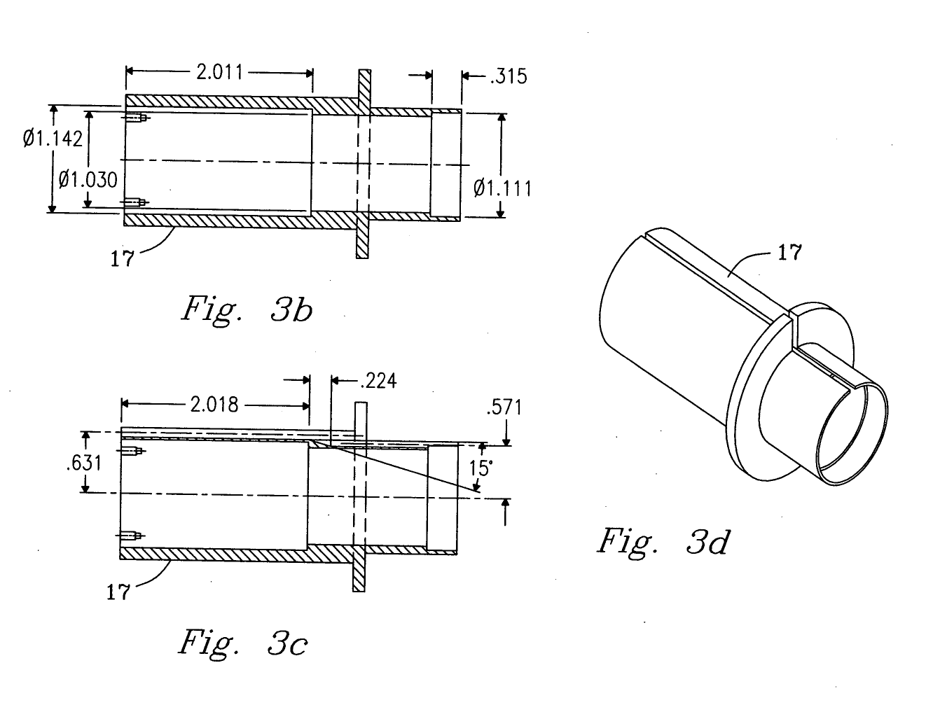

FIGS. 3a-3d present four views of beta tube body 17. FIG. 3a presents outermost horizontal and vertical cross-sectional views and associated dimensions (inches) of beta tube body 17. FIGS. 3b-3c present two interior horizontal cross-sectional views of tube body 17 including interior dimensions (inches). FIG. 3d presents an external view of beta tube body 17.

FIGS. 4a4d present four views of nipple cap 25 used to inhibit external and spurious light from entering chamber 5. FIG. 4a shows a vertical cross-sectional view and corresponding dimensions (inches), including a spherical radial dimension of the rounded interior surface of cap 25. FIG. 4b shows a horizontal cross-sectional view of nipple cap 25 lengthwise through cap 25 and corresponding dimensions, including a spherical radial dimension of the rounded exterior surface of nipple cap 25. Access point 9a is shown for insertion of transfer tube 22. FIG. 4c shows a width-wise cross-sectional view of nipple cap 25 through access point 9a. The radial dimension of access point 9a is shown (˜0.040 inches). FIG. 4d presents a vertical lengthwise cross-section of nipple cap 25 through access point 9a.

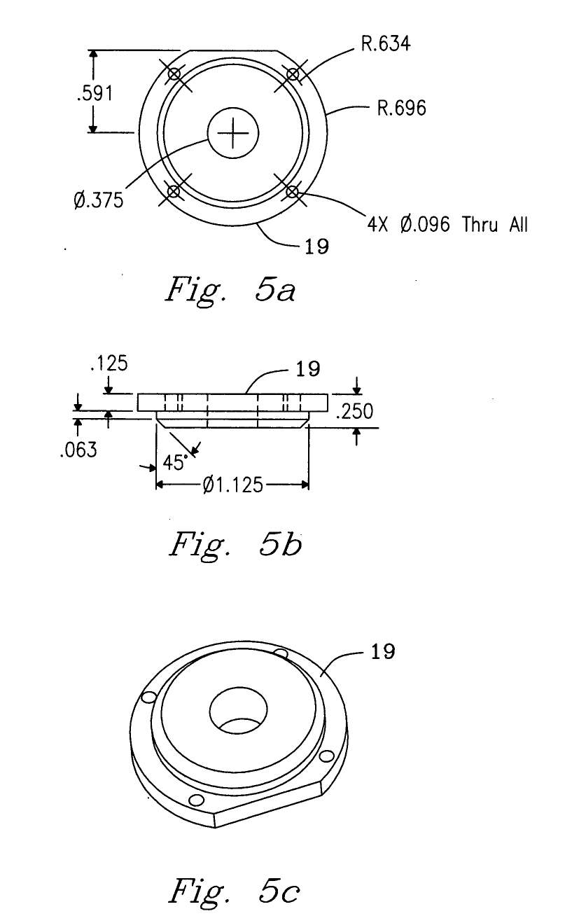

FIGS. 5a-5c present three views of beta tube end cap 19. FIG. 5a shows a back end-on cross-sectional view of beta tube end cap 19 and associated dimensions. FIG. 5b shows a vertical cross-sectional view with corresponding dimensions. FIG. 5c shows a whole top-down view of beta tube end cap 19. No limitations are intended.

FIGS. 6a-6c present three views of chamber body 5a of chamber 5. FIG. 6a is a vertical cross-sectional view through chamber body 5a of chamber 5 and associated dimensions. FIG. 6b illustrates a horizontal cross-section of chamber body 5a through the upper half of chamber 5 and corresponding dimensions including positioning of gas inlet. port 9. FIG. 6c illustrates a horizontal cross-sectional view of chamber body 5a showing relative position of inlet port 9 through the thickness of the wall of chamber body 5a.

FIGS. 7a-7b present two views of end cap 5b of chamber 5. FIG. 7a shows a back end-on view of end cap 5b and associated dimension (˜0.709 inches). FIG. 7b illustrates a vertical cross-sectional view of end cap 5b and associated step dimensions.

FIGS. 8a-8c present three views of photon well detector 90. FIG. 8a presents a vertical cross-sectional view through second means 80 of photon well detector 90 showing high-voltage (HV) input connection 82 and PMT signal (pulse) output connection 84. FIG. 8b presents a lengthwise cross-sectional view through photon well detector 90 including well 72 within photon sensitive scintillating material 70 section and second means 80 section showing high-voltage (HV) input connection 82 and PMT signal (pulse) output connection 84. FIG. 8c shows a horizontal cross-sectional view of photon well detector 90 showing photon sensitive scintillating material 70 section and associated width (˜1.200 inches) and depth (˜1.995 inches) dimensions (inches) of well 72, and second means 80 section showing high-voltage (HV) input connection 82 and PMT signal (pulse) output connection 84. Second axis of symmetry a2 is illustrated in both FIGS. 8b and 8c.

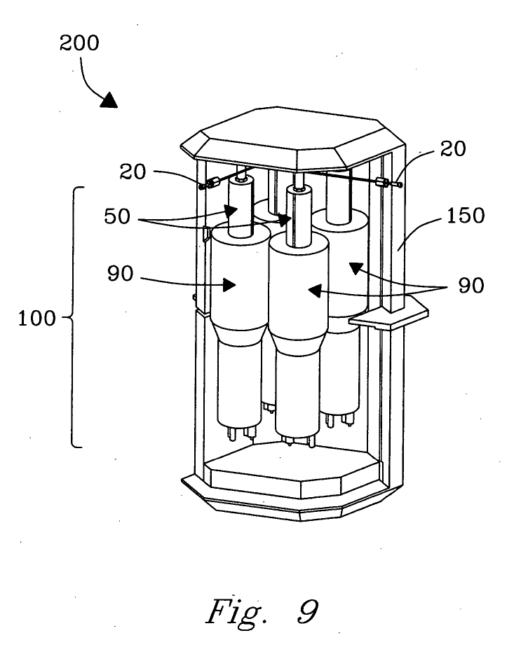

Another embodiment of a coincidence detection apparatus will now be described with reference to FIG. 9.

FIG. 9 illustrates a beta-gamma coincidence apparatus 200 configured with four (4) coincidence detection cells 100, according to another embodiment of the invention. Each detection cell 100 comprises a charged particle detector 50 and a photon well detector 90. In the instant embodiment, each photon well detector comprises a Csl(Na) scintillating material, but is not limited thereto. The scintillating material of each well detector 90 is commercially encased in a thin layer of aluminum (not shown). Coincidence cells 100 of apparatus 200 are positioned within a 2.5 cm thick lead cave 150 to shield them from external cosmic radiation. Internal to cave 150 is a 0.635 cm (˜0.25 inch) layer of copper that shields coincidence cells 100 from any radiation emitted by natural isotopes (e.g., ²¹⁰Pb) present in the lead of cave 150. Apparatus 200 includes other allied components, including tube 20 for transferring analyte gas, described previously herein with reference to FIG. 1. The design in the instant embodiment reduces initial setup and calibration efforts, as each of the coincidence cells 100 including their respective charged-particle detectors 50 and photon well detectors 90 can be calibrated independently. Gain matching is also not required given use of a single PMTs in each respective detector 50 and 90 in each coincidence cell 100, providing for rapid set-up, calibration, and/or ease of replacement. Because each coincidence detection cell 100 operates independently of the others, poor energy or resolution response from, e.g., a defective PMT has minimal impact on any remaining coincidence detection cells 100 present in apparatus 200. In addition, close packing of the four photon well detectors 90 facilitates rejection of stray energies from external cosmic and ambient gamma radiation. Overall, the design retains a maximized solid angle of detection providing excellent detection efficiency.

### ELECTRONICS

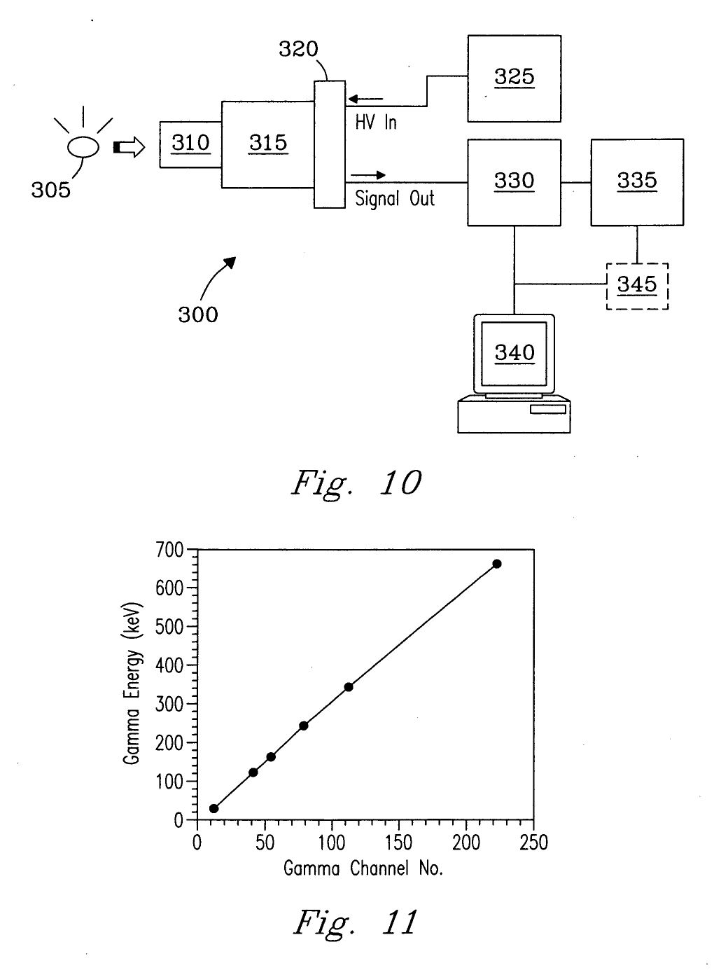

FIG. 10 presents a system 300 of a simple design comprising various electronics, devices, and spectroscopic analysis components for processing signals of one or more coincidence detection cell(s) 100 (not shown). Charged particle detector 50 (not shown) and photon well detector 90 (not shown) may be coupled to similar electronic components within the schematic flow path, as will be understood by those of skill in the art.

As illustrated in the figure, a scintillation source 305 generates a scintillation event in a scintillating material 310. Scintillating material 310 is operatively coupled to a respective photomultiplier tube 315 or like device for capturing light from the event, as detailed herein. Photomultiplier tube 315 is electrically connected to an optional voltage divider 320 linked to a HV supply 325 providing an HV input. A pulse captured from a scintillating event is provided as an output signal to a multichannel analyzer (MCA) 330 where data are accumulated. The signal is further converted through an optional analog-to-digital (A/D) converter (ADC) 335 or like device. Data accumulation and signal conditioning are effected in conjunction with control provided by a central computer 340 equipped with Data Acquisition Software, e.g., as is available commercially from X-ray Instrumentation Associates (XIA) (Newark, Calif., USA), Canberra (Meriden, Conn., USA), Ortec/Ametek (Oak Ridge, Tenn., USA), or like providers. Subsequent analysis is also done using various spectroscopic analysis systems and software, thereby providing spectroscopic data corresponding to the scintillating event(s).

In one embodiment of system 300, beta spectroscopy is performed on fast negative signals collected from PMT 315. PMT 315 signals are first sent to separate channels of MCA 335, e.g., a LeCroy 428F linear fan-in/out. Outputs from each channel are sent through a nanosecond delay unit to a LeCroy 2249A charge integrating analog-to-digital converter (ADC) 335 so that pulse height spectra for each PMT 315 can be individually recorded. Summed PMT signals are sent through appropriate delays to the charge-integrating ADC 335 for subsequent pulse height analysis in computer 340. Outputs from the fan-out modules of MCA 335 from individual PMT signals 315 are sent to an optional discriminator module, e.g., a Phillips model 705 discriminator (Phillips Scientific, Mahwah, N.J., USA) 345. Logic output pulses from discriminator 345 are routed to a coincidence logic module, e.g., an Ortec model CO4020 coincidence logic module (Ortec, Oak Ridge, TN, USA) that generates a 20 ns wide gate pulse use for the integration timing for ADC 335. Pulse height spectra are obtained in a computer 340 or computer-based data acquisition system, e.g., a Macintosh Quadra 900 running KMAX software (Sparrow, Inc., P.O. Box 6102, Miss. State, Miss., USA). All data acquisition systems electronics and analysis systems as will be contemplated by those of skill are within the scope of the present disclosure. No limitations are intended.

In another embodiment, system 300 utilized an in-house built HV supply 325 and Multi-channel Analyzer (MCA) 330, used in conjunction with in-house coded analysis software, i.e., “ARSA Beta-Gamma Viewer”, which components and software have been described extensively, e.g., by Heimbigner et. al. in (Annual DoD/DOE Seismic Research Review—Planning for Verification of and Compliance with the Comprehensive Nuclear-Test-Ban Treaty, New Orleans, La., Published by Defense-Threat-Reduction Agency (2000).), incorporated herein in its entirety. All components as will be implemented by those of skill in the art are within the scope of the disclosure. Thus, no limitations are intended.

### Decay Signatures for Xe Fission Products

Gaseous radioisotopes detectable in beta-gamma coincidence detector 100 of the present invention include, but are not limited to, e.g., carbon [e.g., ¹⁴C], oxygen [e.g., ¹⁵O], argon [e.g., ³⁹Ar, ⁴¹Ar, ⁴²Ar], krypton [e.g., ^{85m}Kr, ^{87m}Kr, ⁸⁸Kr], xenon [e.g., ¹³³Xe, ^{133m}Xe, ^{131m}Xe, ¹³⁵Xe, etc.], radon and daughter products [e.g., ²²²Rn, ²²⁰Rn, ²¹⁸Po, ²¹⁴Pb, ²¹⁴Bi, ²¹⁴Po, ²¹⁰Pb etc], or combinations thereof. In general, any radioisotope can be detected provided the analyte is a gas having measurable beta and/or gamma decay signatures. Radioxenon isotopes are illustrative gases used to test performance of coincidence detector 100. Table 1 lists dominant decay modes of exemplary radioxenon isotopes.

TABLE 1
Dominant decay modes of radioxenon isotopes.^{a}

| | Isotope | | | |
|---|---|---|---|---|
| | ^{131m}Xe | ¹³³Xe | ^{133m}Xe | ¹³⁵Xe |
| Half-life (days) | 11.84 | 5.24 | 2.19 | 0.38 |
| 1° gamma energy | 163.9 | 81.0 | 233.2 | 249.8 |
| (keV) | | | | |
| Gamma abundance (%) | 1.96 | 37 | 10.3 | 90 |
| X-ray energy (keV) | 30 | 31 | 30 | 31 |
| X-ray abundance (%) | 54 | 48.9 | 56.3 | 5.2 |
| Beta-particle endpoint | 346 | 905 | — | — |
| energy | | | | |
| (keV) | | | | |
| Beta-particle abundance | 99 | 96 | — | — |
| (%) | | | | |
| Conversion electron | 129 | 45 | 199 | 214 |
| energy | | | | |
| (keV) | | | | |
| Conversion electron | 60.7 | 54 | 63.1 | 5.7 |
| abundance | | | | |
| (%) | | | | |

^{a}Table of Radioactive Isotopes, Wiley, N. Y., 1986.

Coincidence detection apparatus 100 can be used to detect the four specific xenon (Xe) fission product radionuclides (radioisotopes) based on delayed coincidence counting that provides enhanced sensitivity for detection of radioisotopes. Determination of each of the individual Xe isotopes listed in TABLE 1 is not dependent on decay analysis based on half-life. Apparatus 100 simultaneously or separately provides measurement of both beta and/or conversion electron (CE) radiation spectra having a known and/or measurable energy coincident with the known gamma radiation spectra. In particular, excellent sensitivity is achieved in the beta-gamma coincidence detection apparatus 100 for Xe nuclides tested by measuring the gamma spectra in Nal photon well detectors 90 gated by coincident betas or conversion electrons in chamber 5, described herein, based on unique signatures for each characteristic isotope. The unique signature for ¹³⁵Xe, for example, involves observation of the 249.8 keV gamma in coincidence with the beta spectrum having a maximum energy of 905 keV. Both the gamma transition and beta transition have abundances of over 90% so coincidence efficiency is good. The signature for ¹³³Xe is also unique due to the coincidence between the 81 keV gamma and its preceding beta spectrum. Although the beta spectrum is 99% abundant, the gamma transition is only about 37% abundant due to internal conversion. Signatures for ^{131m}Xe and ^{133m}Xe are based on the coincidence between the conversion electrons of each species and the 30 keV X-rays of each isotope.

The invention will now be further described in the following examples.

### EXAMPLES

The following examples are intended to promote a further understanding of conditions and applications as well as evidence supporting selective deposition of materials, according to the present invention. Example 1 details calibration of photon well detector 90, using gamma energies from a ¹³⁷Cs source, a ¹⁵²Eu source, and/or a radioxenon source. Example 2 describes performance results of photon well detector 90 of coincident detection cell 100. Example 3 details use of Compton scattering of gamma radiation for rapid calibration of coincidence detection cell 100, in particular, calibration of the charged particle detector 50. Example 4 provides performance data for the charged particle detector 50 of the coincidence detection cell 100. Example 5 details radioxenon response of coincidence cell 100. Example 6 details beta-gamma coincidence measurements for chamber 5 using gamma energies from a ¹³⁷Cs source and a radioxenon source, respectively.

### EXAMPLE 1

### Calibration of the Gamma Detector using Gamma Energies from a ¹³⁷Cs Source and a Radioxenon Source

Example 1 details calibration of photon well detector 90, using gamma energies from a ¹³⁷Cs source, a ¹⁵²Eu source, and/or a radioxenon source.

The photon well detector 90 was calibrated as described, e.g., by Reeder et al. [in Nuclear Instruments and Methods in Physics Research A, 521 (2004), pp. 586-599], incorporated herein in its entirety. The gamma energy calibration involved several gamma peaks in the energy range of interest, from about 0 keV to about 662 keV. These are conveniently provided by a ¹⁵²Eu source with useful gamma peaks at 121.8 keV, 163.9 keV, 244.7 keV, and 344.3 keV and a ¹³⁷CS source with a peak, i.e., at 661.7 keV. In addition to these two external sources, an internal source of ^{131m}Xe with X-rays at 30.4 keV was simultaneously counted. Least-squares fit of the following quadratic expression of gamma energy versus channel (Ch_{γ}) number resulted in a calibration curve shown in FIG. 11, corresponding to the following quadratic equation (1):
Eγ=−9.25+3.274 (Chγ)−0.001212(Ch_{γ})² (1)

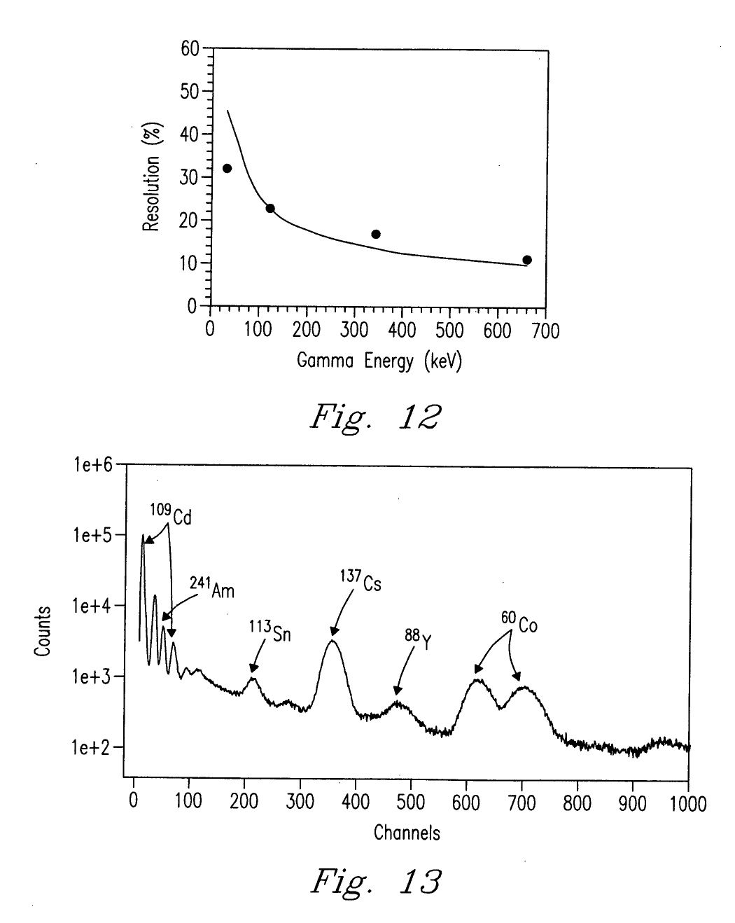

Resolution of calibration lines for peaks from which the calibration curve is derived is shown in FIG. 12 and is further detailed, e.g., by Reeder et al. [in Nuclear Instruments and Methods in Physics Research A, 521 (2004), pp. 586-599].

### EXAMPLE 2

### Performance of the Photon Well Detector in the Coincidence Detection Apparatus

Example 2 describes performance results of photon well detector 90 as a component of coincident detection apparatus 100.

In addition, various detector materials were tested. Performance was measured against Nal(TI). Cesium-Iodide doped with Na or TI were two selections in terms of having comparable density, detection efficiency, energy resolution and light output and timing characteristics. Three well detectors were employed, each differing in the photon sensitive scintillating material comprising the well of the detector. Scintillating materials include, but are not limited to, erg., Nal doped with thallium (TI) [i.e., Nal(TI)], Csl doped with TI [i.e., Csl(TI)] and Csl doped with Na [i.e., Csl(Na)]. The three well detectors were first compared for gamma energies, resolution, and relative efficiency. Crystal size had dimensions of a right cylinder 7.6 cm long by 8.13 cm in diameter, with a 3.1 cm wide by 5.1 cm deep well. 7.5 cm diameter (i.e., oversized) photomultiplier tubes (PMT's) maximized total response for each characteristic wavelength emission for each type of crystal. Initial studies focused on energy response linearity, energy resolution, and efficiency across a wide range of X-ray and gamma energies.

FIG. 13 presents the spectrum obtained using a Csl(TI) well detector 90 (Saint-Gobain, Newbury, Ohio., USA) in conjunction with use of a multi-line gamma source (Isotope Products Laboratory, Burbank, Calif., USA). Each peak was fit to a Gaussian curve to determine the peak centroid and the peak width (FWHM method). Peaks used in the energy calibrations are indicated. The ¹³⁷Cs 661.7 keV peak was used to compare the resolution and efficiency for each of the three detectors tested. Table 2 lists results for each detector 90 tested.

TABLE 2
Results measured for well detector materials.

| | Well Detector Scintillating Material | | |
|---|---|---|---|
| Parameters | NaI (Tl) | CsI (Na) | CsI (Tl) |
| Quadratic | 7.4 × 10⁻⁴ | 5.8 × 10⁻⁴ | 1.7 × 10⁻⁴ |
| term/linear term, | | | |
| (Ch_{γ}) | | | |
| Resolution@ | 6.7 ± 0.1 | 8.7 ± 0.1 | 9.5 ± 0.1 |
| 661.7 keV (%) | | | |
| Relative Efficiency | 24.2 ± 0.1 | 28.3 ± 0.1 | 28.1 ± 0.1 |
| @ 661.7 keV | | | |
| Density (g/cm³)^{a} | 3.67 | 4.51 | 4.51 |
| Primary decay | 230 | 630 | 1000 |
| time (ns)^{a} | | | |

^{a}Saint Gobain, http://www.bicron.com

Linearity of the energy calibration for all three detectors was adequate. However, detection efficiency for the Csl photon well detectors was ˜20% better than other detectors tested.

### EXAMPLE 3

### Calibration of the Charged Particle Detector Using Compton Scattering From ¹³⁷ Cs Source Gammas

Example 3 details use of Compton scattering of gamma radiation for rapid calibration of the charged particle detector 50 of coincidence detection apparatus 100.

A radioxenon source containing, e.g., ^{131m}Xe, ^{133m}Xe, and ¹³³Xe can provide an electron spectrum with two mono-energetic peaks from ^{131m}Xe and ^{133m}Xe, respectively, and a continuous energy distribution from ¹³³Xe. However, use of this source is not ideally suited for unattended or remote operation over extended periods. Consequently, in the instant example, the adopted source of electrons was via Compton scattering of gamma rays in the walls of chamber 5. Detecting the scattered gamma radiation in the gamma-spectrometer tags the electron thereby providing for a determination of the associated energy.

The beta calibration technique is based on Compton scattering of 661.7 keV gamma radiation from, e.g., a ¹³⁷Cs source (Isotope Products Laboratory, Burbank, Calif., USA), producing scattered electrons having energies ranging from about 0 to about 477 keV, matching and/or overlapping the energy range of electrons emitted during beta decay of ¹³³Xe. Thus, the single gamma line from ¹³⁷Cs (more particularly from the ^{137m}Ba daughter of ¹³⁷Cs), is a suitable energy source for 662 keV gammas. The ¹³⁷Cs (an electron) source is inserted into the center of the detector through a hole or transferred via air pressure to a location near the middle of the scintillating (e.g., plastic) material inside the wall of chamber 5. Source location does not need to be exact as the source gamma's irradiate the entire chamber 5. A follow-up procedure is to introduce ^{131m}Xe directly into chamber 5. Introduction of ^{131m}Xe to chamber 5 allows comparison of predicted location and width of the 129 keV conversion electron (CE) peak with actual location and width under identical conditions. The beta and gamma signals from the external ¹³⁷Cs source and internal ^{131m}Xe source are stored as 2-dimensional plots of the pulse heights from both the charged particle detector 50 and photon well detector 90.

The basic assumption in the beta calibration by Compton scattering is that the diagonal region contains events where full energy deposition occurs in both the charged particle detector 50 and photon well detector 90. Thickness the walls of chamber 5 in charged particle detector 50 is selected to stop 346 keV β-energies from ¹³¹Xe inside chamber 5 but is not thick enough to stop maximum energy Compton electrons of ˜477 keV generated within the scintillating material comprising the walls of chamber 5, unless electrons travel along the length of chamber 5. By analyzing only regions along the diagonal, events are eliminated where incomplete energy deposition occurs. Thus, if a single channel on the gamma axis is selected, the corresponding beta spectrum will give a corresponding peak on the beta axis. The energy of this peak is determined from equation (2):
E₀=E_{β}+E_{γ} (2)
where (E₀) is the 661.7 keV gamma peak of ¹³⁷CS, (E₆₂ ) is the beta energy and (E_{γ}) is the gamma energy. The beta energy (E_{β}) is equal to the energy of the initial gamma (E₀) minus the energy of the scattered gamma (E_{γ}). Substituting the 661.7 keV gamma peak value yields the expression in equation (3):
E_{β}+E_{γ}=662 (3)

Equation (3) gives the beta energy scale when the gamma energy scale is determined. For example, as shown by equation (3), the gamma endpoint is at 662 keV; corresponding beta end point is at 477 keV. Thus, the endpoint energy of maximum energy transfer is 477 keV to the scattered electron.

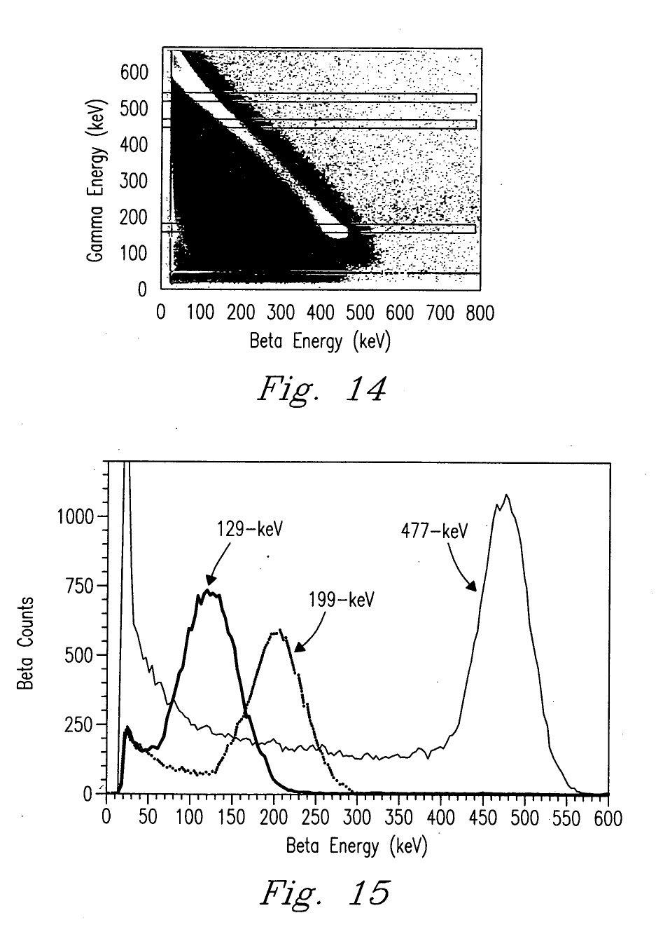

FIG. 14 is a plot showing the 2-dimensional beta-gamma coincidence histogram generated using a ¹³⁷CS source (Isotope Products Laboratory, Burbank, Calif., USA). The histogram shows the Compton electrons scattered in the (e.g., plastic) scintillating material of chamber 5, resulting in scattered gamma-radiation. The diagonal line represents a constant energy line corresponding to addition of the gamma energy to the beta energy, where the scattered electron has energy of 477 keV. Thus, within the beta-gamma coincidence plane, all electron energies from about 0 to about 477 keV are populated. The correlation shown in FIG. 14 allows the determination of the beta energy resolution from ˜15 keV all the way up to the 477 keV endpoint value. Intermediate values can be used to define the beta energy scale and the resolution of chamber 5. Fit of the Gaussian peaks along the constant energy line is an indication of the linearity of the charged particle detector 50 response as well as the CE resolution.

FIG. 15 highlights the narrow regions of the beta-gamma histogram of FIG. 14 at appropriate gamma energies. Highlighting the narrow region in the beta-gamma histogram at appropriate gamma energies gives a projection along the beta axis that has a center at the CE energies for each of the isotopes, in this case, ^{131m}Xe and ^{133m}Xe, as well as the Compton scatter end point energy of 477 keV corresponding to the 662 keV gamma from ¹³⁷CS. Linearity is achieved without time consuming PMT matching. In the figure, overlap between the 129 keV peak and 199 keV peak is about 10%. Minimization of peak overlap is desirable, although counts corresponding to each peak can be determined through standard peak fitting routines, if necessary. In the instant embodiment, the β-energy resolution for charged particle detector 50 employing a single PMT 10 is comparable to other commercial systems. And, no loss in performance of charged particle detector 50 was observed.

The approach described herein provides a reliable means to compare charged particle detector 50 response over a period of weeks, months, and/or years. PMT 10 gain shifts and relative efficiency declines can be measured and tracked to provide a rigorous quality assurance and quality control regime. The technique also benefits from more direct measurements using sources because gamma radiation illuminates the entire chamber 5 whereas β-sources typically illuminate only a material positioned directly in front of the source. Position of (β) and/or (CE) sources can thus give very different β-detector 50 responses depending on how accurately the source is positioned from one insertion to the next.

### EXAMPLE 4

### Performance of the Charged Particle Detector in the Coincidence Detection Apparatus

Example 4 details performance data for the charged particle detector in the coincidence detection apparatus 100.

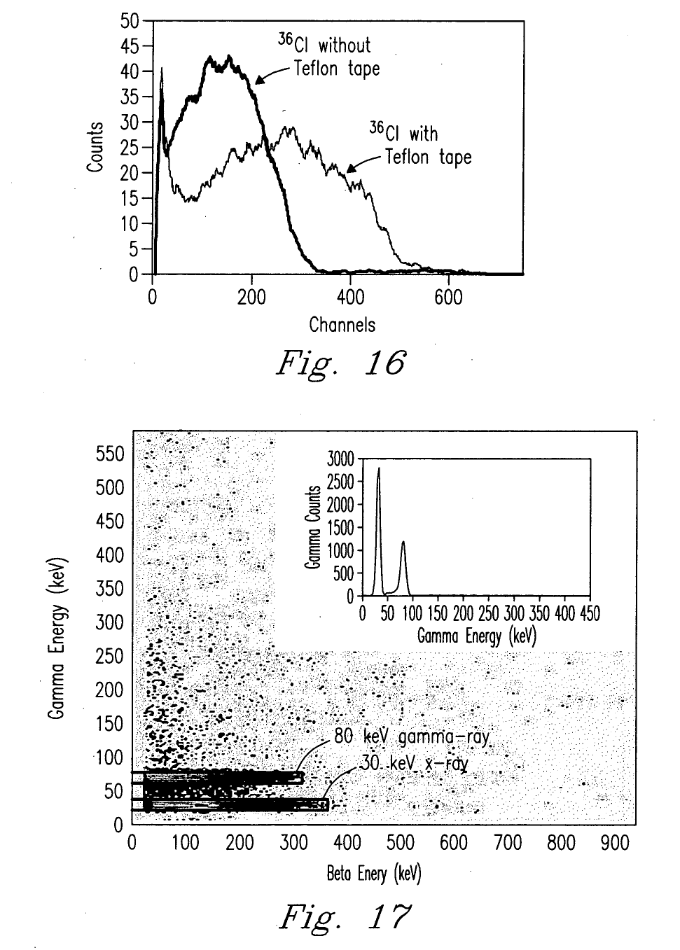

Chamber 5 was fabricated as illustrated in FIGS. 1-8 from a scintillating plastic material, e.g., Bicron® BC-404 (Saint-Gobain, Newbury, Ohio., USA), a non-hygroscopic material having good charged particle energy resolution and robust character. Chamber 5 was tested for use in conjunction with coincidence detector assembly 100. Chamber 5 depth in photon well detector 90 was ˜5.5 cm (˜2.17 inches). In one embodiment, walls of chamber 5 were ˜2.0 mm, sufficiently thin that they did not attenuate 30 keV X-rays emanating from the xenon radioisotopes tested (i.e., ¹³³Xe, ^{131m}Xe, and ^{133m}Xe). Chamber 5 was 28 mm long, with a rounded end to allow scattered light to be refocused back towards PMT 10 coupled to chamber 5 in the coincidence detector assembly 100. PMT 10 was oversized to facilitate collection and measurement of more scintillation photons interacting with the central portion of PMT 10 where conversion efficiency is higher. To further enhance focusing of scattered light back towards PMT 10, chamber 5 was wrapped in 2 layers (˜1 Mils each) of Teflon® tape, but use is not limited thereto. FIG. 16 shows response of chamber 5 to an exemplary beta source, e.g., ³⁶Cl, with and without the added Teflon® covering.

As shown in the figure, addition of Teflon® tape as a reflector provides a significant increase in the total light collected by PMT 10. The ³⁶Cl beta source has a beta end point energy of 1142 keV. The full energy is unlikely to be deposited because the 2 mm thickness of the plastic scintillator used for chamber 5 has a stopping power of ˜450 keV.

A chamber 5 fabricated of Yttrium Aluminum Oxide Perovskite doped with Cerium, i.e., YAP(Ce) (Proteus, Inc., Chagrin Falls, Ohio., USA), an inorganic scintillator having light output comparable to that of Nal(TI) and/or Csl(Na), was also tested. The material is also non-hygroscopic. Cell wall thickness of the test cell was 2.0 mm, which remained too thick (by a factor of 4) for the end use in coincidence detector apparatus 100, given the YAP density of 5.55 g/cm³. However, the 2.0 mm thick YAP cells responded well to both betas and low energy X-rays alike. Thus, YAP is a suitable material, and would be optimized at thicknesses of about 0.5 mm. A chamber 5 fabricated from YAP(Ce) at an appropriate thickness, e.g., of about 0.5 mm, can thus be expected to provide significant improvement in the resolving power of chamber 5, comparable to that obtained for Csl(Na) and/or Nal(TI) photon well detectors 90.

### EXAMPLE 5

### Radioxenon Response

Example 5 details radioxenon response of coincidence detection apparatus 100. Use of medical ¹³³Xe gives a direct measure of the beta energy and resolution as well as providing the complete response of the beta-gamma coincidence detector 100. In addition, allowing the ¹³³Xe to age allows the relative in-growth of the longer lived ^{131m}Xe and provides additional confirmation of CE resolution and response.

FIG. 17 shows a 2-dimensional beta-gamma coincidence spectrum obtained from aged ¹³³Xe sample containing ^{131m}Xe as a contaminate. The plot shows two regions for ¹³³Xe highlighted, a 30 keV X-ray region and an 80 keV gamma region, respectively. The ^{131m}Xe region shows up as a dark spot in the 30 keV X-ray region. The inset graph shows the projection of the data to the gamma-axis, showing the excellent separation achieved between the X-ray and gamma-ray responses. The 30-keV X-rays of ¹³³Xe and the ^{131m}Xe are indistinguishable along the axis, showing the power of using the beta energy and CE energy in coincidence.

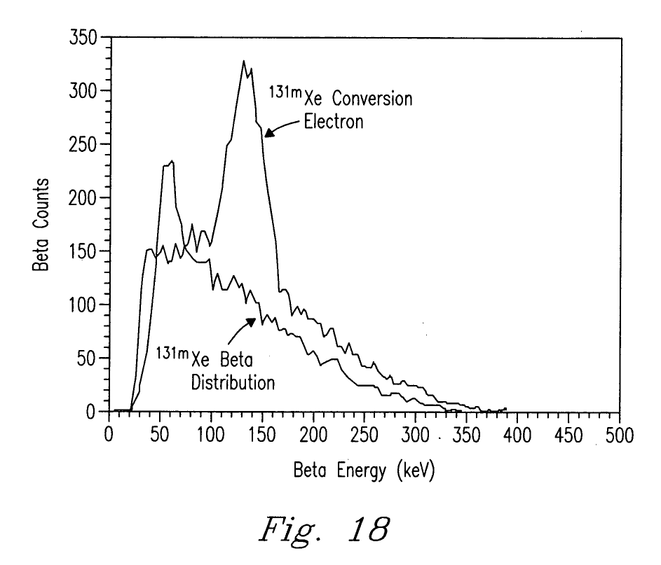

FIG. 18 shows the projection of the two highlighted regions of FIG. 17, respectively, projected onto the beta axis. The 80 keV region provides a pure ¹³³Xe beta distribution peak with no CE interferences. The 30 keV X-ray region provides a ¹³³Xe conversion electron peak at 45 keV (small peak) and a more prominent conversion electron peak centered at 129 keV from the decay of ^{131m}Xe. Resolution is 0.248±0.031.

### EXAMPLE 6

### Beta-Gamma Coincidence Measurements using Gamma Energies from a ¹³⁷Cs Source and a Radioxenon Source

Example 6 details beta-gamma coincidence measurements for coincidence detection apparatus 100 using gamma energies from a ¹³⁷Cs source and a radioxenon source, respectively.

Two tests were run in conjunction with well detector 90, described in Example 1, each comprising a different scintillating material. The first test employed Compton scattering of the 662 keV peak from ¹³⁷Cs e.g., as described by P. Reeder et al. [Nucl. Inst. Meas. A, Vol. 521, Issue: 2-3, pp. 586-599, April 2004], to generate beta-gamma coincidences in coincidence detection apparatus 100. The second technique employed a commercial radioxenon gas source (Isotope Products Laboratory, Burbank, Calif., USA). The gas source is comprised of both ¹³³Xe and ^{131m}Xe isotopes, the metastable isotope ^{131m}Xe being a contaminate present at very low relative levels compared to ¹³³Xe. However, after several months, the metastable isotope decays much less than the more prominent isotope and is therefore more abundant and easily discernable in the mixed gas source. Initial source strength of the ¹³³Xe source (174 MBq) is too high to use, but aging has the effect of decreasing ¹³³Xe activity to usable levels. A second radioactive gas, i.e., ²²²Rn, can be used as well, as described, e.g., by J. I. McIntyre et al. [Jour. Radioanal. Nucl. Chem., 248, No. 3 pp. 629-635, April 2001]. The two daughter products of ²²²Rn, i.e., ²¹⁴Pb and ²¹⁴Bi, both have strong beta-gamma coincidence signatures that are readily detected in the coincidence detector assembly 100 in conjunction with detectors 50 and 90, respectively.

### CONCLUSIONS

The new coincidence detection apparatus and method described in various embodiments herein provide radioisotopic detection efficiency and energy resolution applicable in various charged particle-photon coincident detection and/or fielded coincidence detection systems. The embodiments described herein allow for ease of calibration and for rapid in-field replacement of any of one or more coincidence detection cells employed, including their allied components. For example, negative impacts to PMT's, readout channels, chamber and/or photon scintillating materials that fail are limited to a single coincidence detection cell in a given apparatus. In addition, energy calibration time is reduced and can be done using automated operation and analysis routines, as will be implemented by those of skill in the art.

While the present invention has been described herein with reference to various embodiments thereof, it should be understood that the invention is not limited thereto, and various alternatives in form and detail may be made therein without departing from the spirit and scope of the invention.

We claim:

1. An apparatus for measuring a charged particle-photon coincident radiation emanating from an analyte gas, comprising:
one or more coincidence detection cells, each cell comprising a charged-particle detector and a photon well detector wherein said charged-particle detector comprises a chamber for containing an analyte gas, said chamber being composed of a charged-particle sensitive scintillating material, said charged-particle detector further comprising a first means for detecting scintillation events in said charged-particle sensitive scintillating material from a charged-particle radiation emanating from said gas, said chamber and said first means defining a first axis of symmetry, said photon well detector comprising a photon sensitive scintillating material defining a well, and a second means for detecting scintillation events in said photon-sensitive scintillating material from a photon radiation emanating from said gas, said well and said second means defining a second axis of symmetry; and
wherein said chamber substantially resides within said well whereby said first and said second axes of symmetry are substantially collinear providing for measurement of said charged particle-photon coincident radiation.

2. The apparatus of claim 1, wherein the photon radiation is gamma radiation.

3. The apparatus of claim 1, wherein the charged particle radiation is beta and/or conversion electron radiation.

4. The apparatus of claim 1, wherein the photon sensitive scintillating material is selected from the group consisting of Sodium Iodide (Nal), Cesium Iodide (Csl), Bismuth Germanate (BGO), Gadolinium Silicate (GSO), LaCl₃, LaBr₃, or combinations thereof.

5. The apparatus of claim 4, wherein the photon sensitive scintillating material is undoped.

6. The apparatus of claim 4, wherein the photon sensitive scintillating material is doped with an element selected from the group consisting of Na, TI, Cs, or combinations thereof.

7. The apparatus of claim 5, wherein the photon sensitive scintillating material doped with an element is Csl doped with Na.

8. The apparatus of claim 1, wherein the charged-particle sensitive scintillating material is an organic scintillating material.

9. The apparatus of claim 8, wherein said organic scintillating material is a plastic scintillating material.

10. The apparatus of claim 1, wherein the charged-particle sensitive scintillating material is an inorganic scintillating material.

11. The apparatus of claim 10, wherein the inorganic scintillating material comprises a member selected from the group consisting of Silicon (Si), Calcium Fluoride (CaF), yttrium-aluminum-perovskite (YAP), Bismuth Germanate (BGO), Gadolinium Silicate (GSO), or combinations thereof.

12. The apparatus of claim 11, wherein the inorganic scintillating material is yttrium-aluminum-perovskite doped with cerium (YAP:Ce).

13. The apparatus of claim 1, wherein the interior surface of said chamber comprises a memory reduction material.

14. The apparatus of claim 13, wherein said memory reduction material is selected from the group consisting of Calcium Fluoride (CaF), yttrium-aluminum-perovskite (YAP), or combinations thereof.

15. The apparatus of claim 1, wherein the external surface of said chamber is in contact with a photon reflective material.

16. The apparatus of claim 15, wherein said photon reflective material is Teflon®.

17. The apparatus of claim 1, wherein said first means for detecting scintillation is selected from the group consisting of photomultiplier tube, photocathode, photodiode, phototransistor, charge-coupled device (CCD), or combinations thereof.

18. The apparatus of claim 17, wherein said first means for detecting scintillation is a photomultiplier tube oversized to optimize collection efficiency from said chamber.

19. The apparatus of claim 1, wherein said second means for detecting scintillation is selected from the group consisting of photomultiplier tube, photocathode, photodiode, phototransistor, charge-coupled device (CCD), or combinations thereof.

20. The apparatus of claim 19, wherein said second means for detecting scintillation is a photomultiplier tube with a window diameter greater than the diameter of said chamber to optimize collection efficiency from said chamber.

21. The apparatus of claim 1, wherein the analyte gas is selected from the group consisting of carbon, oxygen, argon, krypton, xenon, radon, or combinations thereof.

22. The apparatus of claim 21, wherein said gas comprises more than one isotope of said gas and/or daughter products thereof.

23. The apparatus of claim 21, wherein said gas is concentrated by at least a factor of about 1000 providing sufficient concentration whereby low-concentration radioisotopes in said gas can be measured.

24. The apparatus of claim 1, wherein said chamber includes a rounded end to increase scintillation collection for detecting scintillation by said first means.

25. The apparatus of claim 1, wherein said apparatus comprises four coincidence detection cells disposed in a square matrix (2×2) configuration.

26. The apparatus of claim 1, wherein said chamber has a wall thickness such that charged-particle scintillation events are substantially captured by said charged-particle sensitive scintillating material and coincident photons are not significantly captured by said charged particle sensitive scintillating material.

27. The apparatus of claim 26, wherein said wall of said wall thickness is in the range from about 0.1 mm to about 2 mm.

28. The apparatus of claim 1, wherein measurement of said charged particle-photon coincident radiation is used for spectroscopic analysis of said analyte gas.

29. A method for measuring charged particle-photon coincident radiation emanating from an analyte gas, comprising the steps:
providing one or more coincidence detection cells, each cell comprising a charged-particle detector and a photon well detector wherein said charged-particle detector comprises a chamber for containing an analyte gas, said chamber being composed of a charged-particle sensitive scintillating material, said charged-particle detector further comprising a first means for detecting scintillation events in said charged-particle sensitive scintillating material from charged-particle radiation emanating from said gas, said chamber and said first means defining a first axis of symmetry, said photon well detector comprising a photon sensitive scintillating material defining a well, and a second means for detecting scintillation events in said photon-sensitive scintillating material from photon radiation emanating from said gas, said well and said second means defining a second axis of symmetry, wherein said chamber substantially resides within said well whereby said first and said second axes of symmetry are substantially collinear;
introducing said analyte gas into said chamber;
detecting scintillation events derived from charged particle-photon coincident radiation emanating from said analyte gas using said charged particle detector and said photon well detector;
thereby providing for measurement of said charged particle-photon coincident radiation.

30. The method of claim 29, wherein the charged-particle sensitive scintillating material is a beta and/or a conversion electron sensitive scintillating material.

31. The method of claim 29, wherein the photon sensitive scintillating material is a gamma sensitive scintillating material.

32. The method of claim 29, further comprising performing spectroscopic analysis of said analyte gas.

33. The method of claim 29, wherein measurement of said charged particle-photon coincident radiation is used for spectroscopic analysis of said analyte gas.

34. A method for performing spectroscopic analysis of an analyte using the apparatus of claim 1.
